(19) United States
(12) Patent Application Publication
(10) Pub. No.: US 2012/0074131 A1
(43) Pub. Date: Mar. 29, 2012

(54) INTEGRATED RESISTIVE HEATERS FOR MICROELECTRONIC DEVICES AND METHODS UTILIZING THE SAME

(75) Inventor: Scott Eugene Olson, Eagan, MN (US)

(73) Assignee: SEAGATE TECHNOLOGY LLC, Scotts Valley, CA (US)

(21) Appl. No.: 12/893,007

(22) Filed: Sep. 29, 2010

(51) Int. Cl. H05B 3/06

(52) U.S. Cl. 219/542

(57) ABSTRACT

A device having a substrate having a first surface and a second opposing surface; and at least one electrical connection assembly, wherein each electrical connection assembly includes: a resistive heater disposed on the first surface of the substrate, wherein the resistive heater is electrically connected to a circuit via a heater electrical connection; an electrical connection precursor, wherein the electrical connection precursor includes a fusible conductive material that is electrically connected to a lead; and a first insulating layer, wherein the resistive heater is disposed beneath the electrical connection precursor, wherein the first insulating layer functions to electrically insulate the resistive heater and the heater electrical connection from the electrical connection precursor and the lead, and wherein activation of the resistive heater functions to at least partially flow the fusible conductive material, wherein each electrical connection assembly can be activated individually by passing a current through the resistive heater.

### BACKGROUND

Flip chip is the name given to a method for interconnecting semiconductor devices (for example integrated circuits) to external circuitry using solder bumps that have been deposited onto the devices. The solder bumps are deposited on the pads of the device on the top side of the wafer during the final wafer processing step. In order to mount the device onto the external circuitry (for example a circuit board or another chip or wafer), the device is flipped over so that its top side faces down. The upside down device is then aligned so that its pads align with matching pads on the external circuit. The solder is then flowed by heating the entire structure to complete the interconnect.

Flip chip methods are commonly utilized to electrically connect recording heads for disc drives to electrical circuits. As in all flip chip methods, the deposited solder bump has to be heated in order to reflow the solder and complete the electrical connection. However, the elevated temperatures that are required to melt the solder may damage the head and nearby components on the circuit assembly. Because of this problem, modified methods of heating the solder bump have been utilized to try to localize the heating. For example, heated gasses can be delivered through small nozzles, or a laser (or other beam of light) can be focused onto the solder bump. Even these methods can still heat a relatively large area around the solder joint.

Another problem that is encountered in using a flip chip method for electrically connecting recording heads to electrical circuits is the need to precisely control the pitch and roll angles of the recording head relative to a fixed surface in the drive. Existing systems do not control the pitch and roll angles during reflow. Post-reflow adjustment of the metal suspension attached to the recording head is thus required to achieve the necessary pitch and roll angles.

Because of these problems in existing flip chip methods of interconnecting, there remains a need for other methods.

### BRIEF SUMMARY

A device having a substrate having a first surface and a second opposing surface; and at least one electrical connection assembly, wherein each electrical connection assembly includes: a resistive heater disposed on the first surface of the substrate, wherein the resistive heater is electrically connected to a circuit via a heater electrical connection; an electrical connection precursor, wherein the electrical connection precursor includes a fusible conductive material that is electrically connected to a lead; and a first insulating layer, wherein the resistive heater is disposed beneath the electrical connection precursor, wherein the first insulating layer functions to electrically insulate the resistive heater and the heater electrical connection from the electrical connection precursor and the lead, and wherein activation of the resistive heater functions to at least partially flow the fusible conductive material, wherein each electrical connection assembly can be activated individually by passing a current through the resistive heater.

A device including: a. a first portion, the first portion including a substrate having a first surface and a second opposing surface; and at least one electrical connection assembly, wherein each electrical connection assembly includes: a resistive heater disposed on the first surface of the substrate, wherein the resistive heater is electrically connected to a circuit via a heater electrical connection; an electrical connection precursor, wherein the electrical connection precursor includes a fusible conductive material that is electrically connected to a lead; and a first insulating layer, wherein the resistive heater is disposed beneath the electrical connection precursor, wherein the first insulating layer functions to electrically insulate the resistive heater and the heater electrical connection from the electrical connection precursor and the lead, and wherein activation of the resistive heater functions to at least partially melt the fusible conductive material, wherein each electrical connection assembly can be activated individually by passing a current through the resistive heater; and b. a second portion, the second portion including: an active device; and a device contact pad electrically connected to the active device, wherein the device contact pad of the second portion and the fusible conductive material of the first portion are electrically and physically connected affording electrical control of the active device through the first portion of the device.

A method of electrically and physically connecting two portions of a device, the method including the steps of: a. placing a first portion of the device in proximity with a second portion of the device, wherein the first portion includes: a substrate having a first surface and a second opposing surface; and at least one electrical connection assembly, wherein each electrical connection assembly includes: a resistive heater disposed on the first surface of the substrate, wherein the resistive heater is electrically connected to a circuit via a heater electrical connection; an electrical connection precursor, wherein the electrical connection precursor includes a fusible conductive material that is electrically connected to a lead; and a first insulating layer, wherein the resistive heater is disposed beneath the electrical connection precursor, wherein the first insulating layer functions to electrically insulate the resistive heater and the heater electrical connection from the electrical connection precursor and the lead, and wherein activation of the resistive heater functions to at least partially melt the fusible conductive material, wherein each electrical connection assembly can be activated individually by passing a current through the resistive heater; and the second portion includes: an active device; and a device contact pad electrically connected to the active device; b. passing a current through the resistive heater of the first connection assembly causing the fusible conductive material to at least partially melt; and c. contacting part of the first portion with part of the second portion to form an electrical and physical connection between the first portion and the second portion to form a device.

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings, in which:

FIG. 1A is a schematic cross section of an article disclosed herein that includes at least two electrical connection assemblies;

FIGS. 1B and 1C are schematic top down views of articles disclosed herein;

FIG. 2 is a schematic cross section of an article disclosed herein that includes additional optional components in the electrical connection precursor;

FIG. 3 is a schematic cross section of an article disclosed herein that includes additional optional components in the electrical connection precursor;

FIG. 4 is a schematic plan view of an article that includes a plurality of electrical connection assemblies;

FIG. 5 is a schematic cross section of a disclosed device that includes a first and second portion;

FIGS. 6A through 6D are flowcharts depicting exemplary methods as disclosed herein;

FIG. 7 is a schematic cross section of a disclosed device that includes a first and second portion with the second portion disposed at an angle with respect to the principle axis of the first portion; and

FIG. 8 is a system that includes an exemplified device and components for measuring the angle of the second portion with respect to the first portion.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

“Include,” “including,” or like terms means encompassing but not limited to, that is, including and not exclusive.

Disclosed herein are articles and devices that include at least one resistive heater. The articles can be useful in flip chip bonding processes. Current can be passed through the at least one resistive heater to cause solder that is part of an electrical connection precursor to flow. The article can then be physically and electrically connected to a second article that includes an active device (for example) via the reflowed solder. Disclosed articles can offer advantages over other articles used in flip chip bonding methods because the solder in each electrical connection precursor can be caused to flow individually, which can offer flexibility in bonding as well as allow for localized heating of only the area of the article containing the solder.

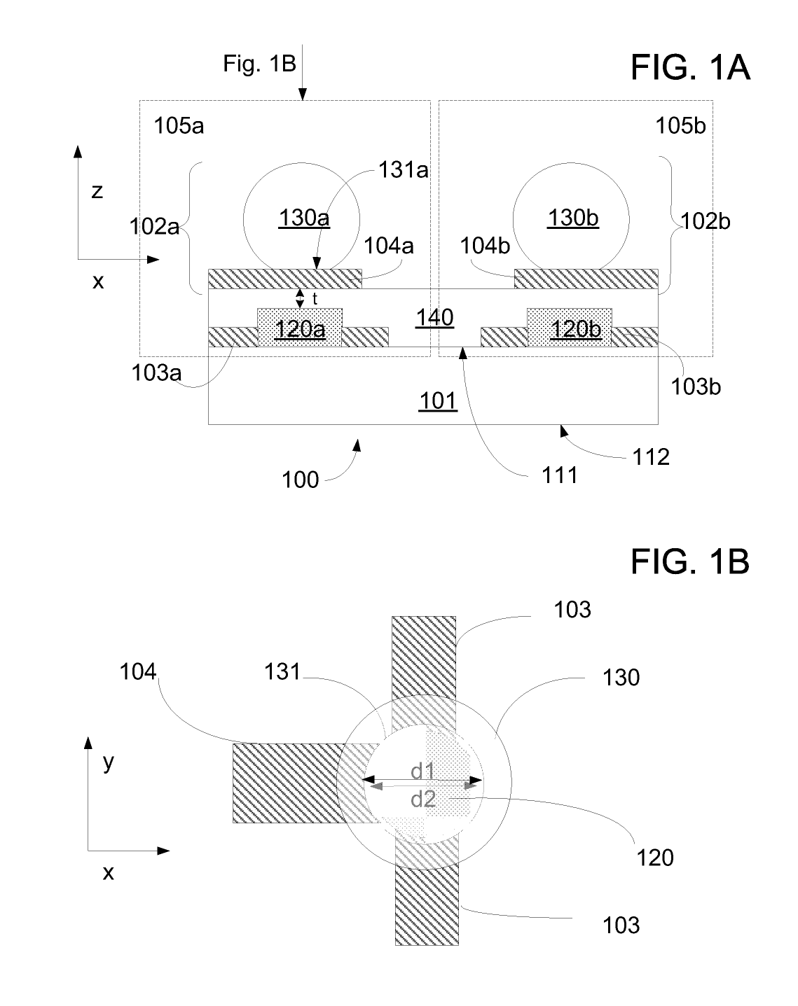

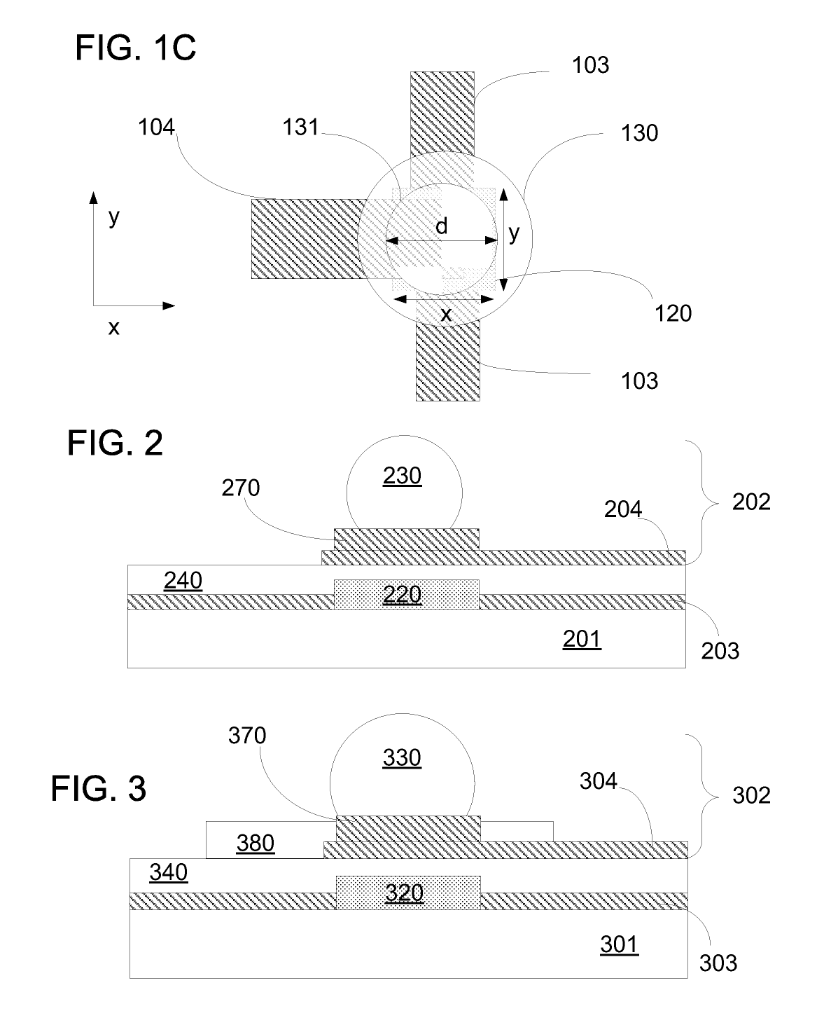

FIG. 1A illustrates a schematic cross sectional view of an exemplary article as disclosed herein. The article 100 includes a substrate 101 and at least one electrical connection assembly 105a and 105b. The substrate 101 can generally have a first major surface 111 and a second major surface 112, wherein the first and second surfaces are opposing. The substrate can be any substrate commonly utilized in semiconductor and integrated circuit fabrication. Exemplary substrates include, for example silicon, a mixture of silicon and germanium, and other similar materials. In embodiments, the substrate can be a flexible material, for example a flexible plastic such as polyimide (for example Kapton® polyimide available from DuPont, Wilmington, Del.) that can but need not have structures, such as electrical circuits for example, embedded therein. In embodiments, the substrate can also be a printed circuit board (PCB) made of an epoxy laminate for example. In embodiments the flexible plastic can have an electrical circuit embedded therein and can be part of a head-gimbal assembly (HGA). The at least one electrical connection assembly can be located on the substrate, completely in the substrate, partially in the substrate, or some combination thereof. In embodiments, the at least one electrical connection assembly is located on a first surface of the substrate.

A single substrate 101 can include one or more than one electrical connection assemblies, of which 105a and 105b are examples. Although FIG. 1A includes two electrical connection assemblies 105a and 105b, the discussion herein will refer to the components of either. It will be understood that the details discussed herein could be applied to components of either, both, or all of the electrical connection assemblies in an article. A single electrical connection assembly 105 includes a resistive heater 120, an electrical connection precursor 102, and at least a portion of an insulating layer 140. The resistive heater 120 is electrically connected to a circuit via a heater electrical connection 103. The heater electrical connection 103, and the resistive heater 120 can be considered part of the circuit, can be considered as being connected to the circuit, or combinations thereof. The electrical connection precursor 102 can include at least a fusible conductive material 130 that is electrically connected to a lead 104.

A resistive heater 120 can generally be made of a material that can generate heat upon application of a current there through. In embodiments, the resistive heater 120 can be configured so that application of a current there through generates sufficient heat to cause at least a portion of the fusible conductive material 130 to melt, flow, or soften. Properties of the resistive heater 120 that can be chosen to provide sufficient current include, for example, the material of the resistive heater, the location of the resistive heater with respect to the electrical connection precursor 102, the shape of the resistive heater, the dimensions of the resistive heater, the shape and/or dimensions of the resistive heater with respect to the shape and/or dimensions of the fusible conductive material, the material of the insulating layer 140, the dimensions of the insulating layer 140 between the resistive heater 120 and the fusible conductive material 130, other factors not discussed herein, and combinations thereof.

Properties of one or more of the resistive heater, the insulating layer, and/or the fusible conductive material can affect and dictate, at least in part, the properties of the others. For example, as a more resistive material is utilized for the resistive heater, the dimensions of the resistive heater can be decreased because smaller amounts of a more resistive material can produce the same heat (or thermal energy) as larger amounts of a less resistive material. Similarly, as a less insulative insulating layer (either less insulating material or a thinner layer) is utilized, the material for the resistive heater can be less resistive or less material can be utilized (or a combination thereof) because the energy will more easily be able to reach the fusible conductive material. Similarly, as the melting point of the fusible conductive material is lowered, the heat necessary to melt or flow it is decreased, therefore less resistive materials can be utilized for the resistive heater, less material can be utilized for the resistive heater, a less insulating material can be utilized for the insulating layer, a thinner layer can be utilized for the insulating layer, or combinations thereof. One of skill in the art, having read this specification, would understand how these variables interplay and how they could be utilized together to determine characteristics of disclosed articles.

The material chosen for the resistive heater 120 can depend at least in part on the thickness of the resistive heater 120, the thickness of the insulating layer 140 above the area of the resistive heater 120, the type and quantity of the fusible conductive material 130, other factors not discussed herein, or combinations thereof. Materials that are more resistive can generally output the same of amount of heat using a lower current. The heat dissipated from a resistor is proportional to its resistance times the current squared. Using higher resistance materials would require increasing the voltage of the current to maintain the same heat output. In embodiments, if the resistance of the material is too high, the voltage that is required to generate sufficient heat output could become too high and damage the substrate, or a structure contained in the substrate. In embodiments, the resistive material and the voltage utilized is chosen so that the temperature of the resistive material remains below (in embodiments well below) the melting point o the resistive material. In embodiments, the resistive material and the voltage utilized is chosen so that the temperature of the insulating layer remains below (in embodiments well below) the glass transition temperature, melting temperature or any other phase transition temperature of the insulating layer material. In embodiments, the resistive material and the voltage utilized is chosen so that the amount of heat dissipated in the substrate does not lead to deformation of the substrate or any structures formed therein or thereon.

In embodiments, materials that can be utilized as the material of the resistive heater have a resistivity of not more than 1000 ohm-meters. Exemplary materials for the resistive heater include for example copper (Cu), nickel (Ni), nichrome, tungsten (W), titanium (Ti), vanadium (Va), platinum (Pt), silicon (Si), germanium (Ge), or combinations thereof. In embodiments, a resistive heater can include platinum (Pt), titanium (Ti), silicon (Si), or germanium (Ge).

The location of the resistive heater 120 with respect to the electrical connection precursor or the fusible conductive material 130 can also play a role in configuring the resistive heater 120 so that application of a current there through generates sufficient heat to cause the fusible conductive material 130 to at least partially reflow. Generally, the temperature at which a fusible conductive material will reflow is a few degrees above the melting temperature of the fusible conductive material In embodiments, at least part of the resistive heater 120 is disposed beneath or below the electrical connection precursor 102. As used herein, the terms “beneath” or “below” are used interchangeably and mean that the resistive heater 120 is located closer to the substrate 101 (or deeper within the substrate 101 in embodiments where the components are located at least partially in the substrate) than the electrical connection precursor 102. In embodiments where a resistive heater is at least partially beneath the electrical connection precursor, there is an axis through at least part of the electrical connection precursor that intersects at least part of the resistive heater. In the cross section of the particular embodiment depicted in FIG. 1A, the resistive heater 120 is at least partially beneath the electrical connection precursor 102 in the z axis.

In embodiments, at least part of the resistive heater 120 is disposed beneath the electrical connection precursor 102 but is electrically insulated from the electrical connection precursor 102. In embodiments, the insulating layer 140 functions to electrically insulate the resistive heater 120 from the electrical connection precursor 102. In embodiments, the resistive heater 120 is positioned beneath the electrical connection precursor 102. In embodiments, the resistive heater 120 is positioned beneath the fusible conductive material 130 of the electrical connection precursor 102. In embodiments, the resistive heater 120 is positioned below but physically and electrically separated from the electrical connection precursor 102. In embodiments, at least most of the resistive heater 120 is disposed beneath at least most of the fusible conductive material 130. In embodiments, the resistive heater 120 can be beneath and mostly congruous with the fusible conductive material 130. In embodiments, the resistive heater 120 can be beneath and substantially congruous with the fusible conductive material 130.

In embodiments, the shape of the resistive heater 120 can affect the ability of the resistive heater to generate sufficient heat upon current flow to cause at least a portion of the fusible conductive material 130 to melt or soften. In embodiments, the resistive heater can have a rectangular cross section, a square cross section, an ellipsoidal cross section, a circular cross section, coiled, zigzag, square wave, or an “S” curve for example. In embodiments, the resistive heater can have a cross section that is at least somewhat circular. In embodiments, the resistive heater can have a cross section that is substantially circular. In the embodiment depicted in FIG. 1A, the resistive heater 120 could have a cross section that is rectangular, square, ellipsoidal, or circular depending on the dimension of the resistive heater 120 in the y axis (not shown in FIG. 1A). As seen in FIG. 1B, the exemplary resistive heater 120 pictured therein has a circular cross section.

In embodiments, the resistive heater can be configured so that a cross section thereof is at least somewhat similar to the shape (or a cross section) of the fusible conductive material 130 before a current is flowed through the resistive heater. In embodiments, the resistive heater can be configured so that the cross section thereof is substantially similar to the shape (or cross section) of the fusible conductive material 130 before a current is flowed through the resistive heater. In embodiments, the resistive heater can have a substantially circular cross section and the fusible conductive material can also have a substantially circular cross section.

As seen in FIG. 1B, which is a top down view from the z axis, the resistive heater 120 in this embodiment has a circular cross section. As seen in FIGS. 1A and 1B, the fusible conductive material 130 makes contact with the rest of the article at a contact surface 131. In embodiments, the resistive heater 120 can have a cross section that is substantially similar to the cross section of the contact surface 131. As seen in FIG. 1B, the resistive heater 120 has a circular cross section and the contact surface 131 also has a circular cross section.

In embodiments, the resistive heater 120 can be similar in size to at least a portion of the electrical connection precursor 102. In embodiments, the resistive heater 120 can be similar in size to the contact surface 131 of the fusible conductive material 130. In embodiments, the area of the resistive heater 120 can be similar to the area of the contact surface 131 of the fusible conductive material 130. In the embodiment depicted in FIG. 1B, the resistive heater 120 has an area that would be given by π(d2/2)²; and the contact surface 131 would have an area of π(d1/2)². In embodiments the area of the resistive heater 120 can be within about ±30% of the area of the contact surface 131. In embodiments the area of the resistive heater 120 can be within about ±20% of the area of the contact surface 131. In embodiments the area of the resistive heater 120 can be within about ±10% of the area of the contact surface 131. In embodiments the area of the resistive heater 120 can be within about ±5% of the area of the contact surface 131. In embodiments, the area of the resistive heater 120 can be substantially the same as the area of the contact surface 131. In embodiments, the resistive heater 120 and the contact surface area 131 are both of a size that activation of the resistive heater 120 will not substantially heat surrounding areas of the device and/or adjacent bonds.

FIG. 1C depicts a top down view from the z axis of another embodiment. In this example, the resistive heater 120 has a rectangular cross section. The resistive heater 120 has an area of x*y, with x and y being the width and length as shown in FIG. 1C. The contact surface 131 of the fusible conductive material 130 has an area of π(d/2)². In embodiments, the area of the contact surface 131 and the area of the resistive heater 120 can be within about ±30%. In embodiments the area of the resistive heater 120 can be within about ±20% of the area of the contact surface 131. In embodiments the area of the resistive heater 120 can be within about ±10% of the area of the contact surface 131. In embodiments the area of the resistive heater 120 can be within about ±5% of the area of the contact surface 131. In embodiments, the area of the resistive heater 120 can be substantially the same as the area of the contact surface 131.

In embodiments, the resistive heater 120 can have a cross section that is substantially similar to the cross section of the contact surface 131 of the fusible conductive material 130 and can have an area that is substantially the same as the area of the contact surface of the fusible conductive material. In embodiments, both the resistive heater and the fusible conductive material can have substantially circular cross sections and the area of the resistive heater and the contact surface of the fusible conductive material can be substantially the same.

Other portions of disclosed articles can also play a role in configuring the resistive heater to be able to at least partially melt or flow the fusible conductive material upon application of an electrical current to the resistive heater. One such portion is the insulating layer. The article depicted in FIG. 1A shows an insulating layer 140 that interacts with both of the electrical connection assemblies 105a and 105b pictured therein. It should be understood by one of skill in the art, having read this specification that the insulating layer can be a single unitary layer, multiple layers and/or structures that can function as a single unitary layer, multiple layers and/or structures that can function as multiple layers, or a combination thereof. Further description herein refers to the insulating layer 140, however it will be understood that multiple layers and/or structures can be utilized to carry out the functions as described herein.

As discussed above, the insulating layer 140 functions to at least electrically insulate the resistive heater 120 and the heater electrical connection 103 from the electrical connection precursor 102. In embodiments, the insulating layer 140 can function to electrically and physically insulate the resistive heater 120 and the heater electrical connection 103 from the electrical connection precursor 102. The materials of the insulating layer 140 allows heat (or thermal energy) generated from the resistive heater 120 to reach the fusible conductive material 130.

The insulating layer 140 can be made of any material that is electrically insulating. The material of the insulating layer 140 is also at least somewhat thermally conductive. Exemplary materials include alumina (Al₂O₃), zirconia (ZrO₂), silicon dioxide (SiO₂), silicon nitride (Si₃N₄), and polymeric insulators such as polyimides, polyimide laminates, epoxies, epoxy laminates, silicone, and materials generally utilized as photoresist. Exemplary materials can also include those that have very high thermal conductivity (for example, at least about 100 W/mK) but are very good insulators. Specific exemplary types of these materials include for example aluminum nitride (AlN), beryllium oxide (BeO), diamond, diamond like carbon (DLC), or chemical vapor deposited (CVD) diamond. In embodiments, polyimide or silicone can be utilized for the insulating layer.

The thickness of the insulating layer 140 can also be configured to allow the resistive heater 120 to be able to at least partially melt or flow the fusible conductive material 130 upon application of an electrical current to the resistive heater. In embodiments, only the thickness of the insulating layer 140 between the resistive heater 120 and the electrical connection precursor 102 is relevant to whether or not the resistive heater can at least partially melt or flow the fusible conductive material 130 upon application of an electrical current to the resistive heater 120. This thickness, which can be referred to as the effective insulating layer thickness, is designated as t in FIG. 1A.

In embodiments, the effective insulating layer thickness, t, can depend on the material of the insulating layer material. In embodiments that utilize materials such as alumina (Al₂O₃), zirconia (ZrO₂), silicon dioxide (SiO₂), silicon nitride (Si₃N₄), and polymeric insulators such as polyimides, polyimide laminates, epoxies, epoxy laminates, silicone, and materials generally utilized as photoresist, the effective insulating layer thickness, t, can be less than about 100 nanometers. In embodiments that utilize high thermal conductivity materials such as aluminum nitride (AlN), beryllium oxide (BeO), diamond, diamond like carbon (DLC), or chemical vapor deposited (CVD) diamond, the effective insulating layer thickness, t, can range from about 10 μm to about 100 μm. In still other embodiments that utilize high thermal conductivity materials such as aluminum nitride (AlN), beryllium oxide (BeO), diamond, diamond like carbon (DLC), or chemical vapor deposited (CVD) diamond, the effective insulating layer thickness, t, can be about 20 μm to about 50 μm thick. In an embodiment, the insulating layer can be made of aluminum nitride (AlN) and can have a thickness of about 25 μm

As seen in FIG. 1A, an electrical connection precursor 102 can include a fusible conductive material 130 and a lead 104. The lead 104 is electrically connected to the fusible conductive material 130. In the embodiment shown in FIG. 1A, the fusible conductive material 130 physically contacts the lead 104 at the contact surface 131.

The fusible conductive material 130 can include any material that can be caused to at least partially melt or flow upon application of a current to the resistive heater and is electrically conductive. In embodiments, the fusible conductive material 130 can be one that has a melting point between about 90° to about 450° C. In embodiments, the fusible conductive material 130 can be one that has a melting point between about 180° to about 190° C.

In embodiments, the fusible conductive material 130 can include solders that include tin, lead, copper, zinc, silver, or some combination thereof. In embodiments, tin/lead solders, copper/zinc solders, copper/silver solders, tin/copper solders, tin/zinc solders, tin/silver solders, tin/silver/copper solders, tin/gold, and similar solders including smaller amounts of other elements can be utilized. In embodiments, alloys of tin, silver, and copper (a tin/silver/copper alloy) can be utilized. In embodiments, polymeric materials such as silver-filled epoxies, tin-filled epoxies, or conductive adhesives can be utilized.

In embodiments, the fusible conductive material 130 can be spherical and have diameters from about 5 μm to about 100 μm. In embodiments, the fusible conductive material 130 can be a solder ball that can be formed using known techniques.

The lead 104 is electrically connected to the fusible conductive material 130. Once the article is electrically connected to a second article, the lead 104 can electrically connect an active device in the second article to external circuitry. Although the lead 104 is shown as a single, unitary portion, it should be understood that the lead 104 can include multiple portions and can generally be configured in any fashion to afford the desired electrical connections. The lead 104 can generally be made of an electrically conductive material. In embodiments, the lead 104 can be made of copper, gold, titanium, platinum, nickel, or combinations thereof. An exemplary material for the lead 104 includes copper with a nickel/gold protective coating.

Electrical connection precursors as disclosed herein can also optionally include other components. FIG. 2 depicts an example of an embodiment of an article including a single electrical connection precursor 202 (although articles including multiple electrical connection assemblies such as those depicted are also contemplated). The electrical connection precursor 202 in this embodiment includes a fusible conductive material 230 that is electrically connected to a lead 204. In this embodiment, the fusible conductive material 230 is electrically connected to the lead 204 via a contact pad 270. The contact pad 270 can be electrically and physically connected to both the fusible conductive material 230 and the lead 204. The contact pad 270 can function to provide a better electrical connection than an electrical connection precursor that does not include a contact pad. The contact pad 270 can also function to confine the material of the fusible conductive material 230 once the material is melted by heat generated from the resistive heater. The insulating materials surrounding the contact pad 270 can function to form a mask that can contain the fusible conductive material on the contact pad 270 (which can be characterized as a wettable metal surface).

The contact pad 270 can generally be circular, elliptical, rectangular or square in shape, and can generally be made of an electrically conductive material. In embodiments, the contact pad 270 can be generally be made of an electrically conductive material. In embodiments, the contact pad 270 can be made of copper, gold, titanium, platinum, nickel, or combinations thereof. An exemplary material for the contact pad 270 includes copper with a nickel/gold protective coating.

Articles as disclosed herein can also include a second insulating layer. An embodiment that includes such a layer can be seen in FIG. 3. The embodiment depicted in FIG. 3 includes a second insulating layer 380. The second insulating layer 380 can be made of the same or a different material than the first insulating layer 340 is made of. The second insulating layer 380 can be made of any material that is electrically insulating. Exemplary materials include alumina (Al₂O₃), zirconia (ZrO₂), silicon dioxide (SiO₂), silicon nitride (Si₃N₄), and polymeric insulators such as polyimides, polyimide laminates, epoxies, epoxy laminates, and materials generally utilized as photoresist. In embodiments, polyimide can be utilized for the second insulating layer.

The second insulating layer 380 can generally function to electrically insulate the resistive heater of one electrical connection assembly from the resistive heater of another electrical connection assembly. The second insulating layer 380 can also or alternatively function to physically isolate the fusible conductive material once it has been melted. In this capacity, the second insulating layer 380 can be characterized as acting like a mask or wick stop layer. This can more effectively maintain the fusible conductive material within a defined area, for example, in physical contact with only the contact pad 370 once it is melted or reflowed before it solidifies again.

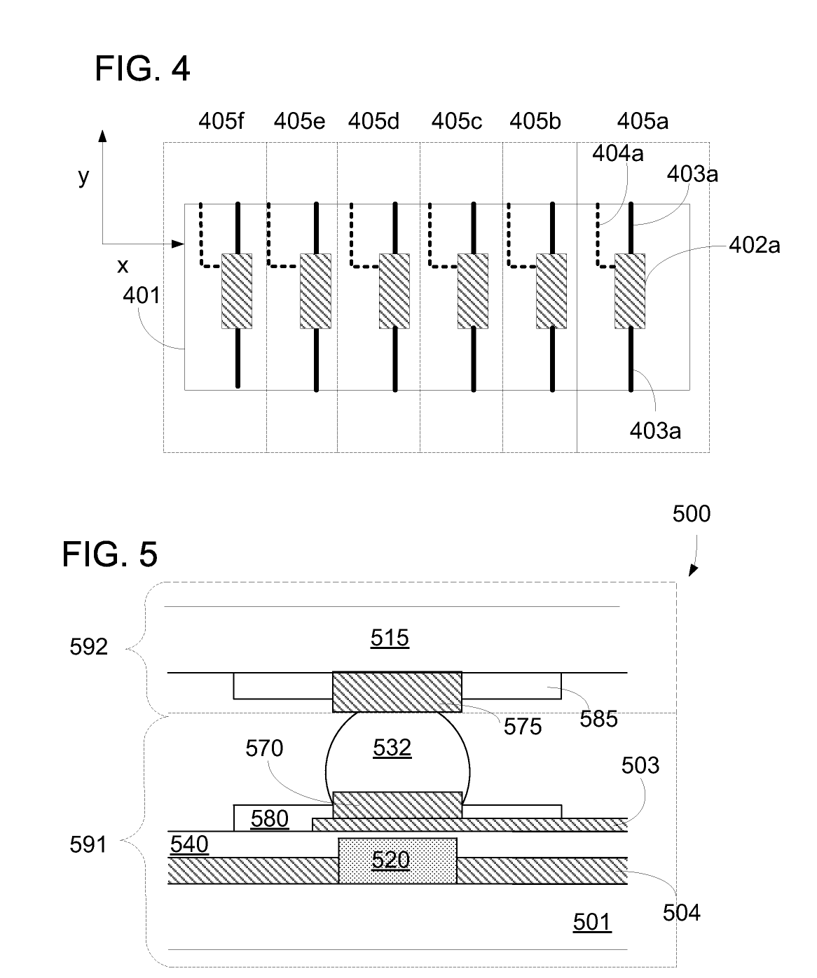

In embodiments, the substrate can include a plurality of electrical connection assemblies. An example of an article including six electrical connection assemblies 405a through 405f is depicted in FIG. 4. In embodiments, a substrate that includes eight electrical connection assemblies configured in three rows (one row of three, followed by one row of two, followed by one row of three) that are staggered in a second direction can be utilized. The electrical connection assemblies 405a through 405f can be arranged in any fashion on the substrate 401. It should also be understood that any number or configuration of electrical connection assemblies can be formed on a substrate. The embodiments presented herein are only exemplary and should not be taken as limiting. An exemplary substrate could also include twelve electrical connection assemblies by repeating the row of electrical connection assemblies seen in FIG. 4 in either direction along the y axis. An exemplary substrate could also include eighteen (or any other multiple of six) electrical connection assemblies by repeating the row of electrical connection assemblies a multiple of times in either (or both) directions along the y axis. It should also be understood that further electrical connection assemblies can be added along the x axis in either or both directions. In embodiments, a plurality of electrical connection assemblies can be arranged on the substrate 401 in a way that allows the substrate 401 to be separated to afford a plurality of articles that each includes one (or more) of the electrical connection assemblies.

Articles as disclosed herein can offer advantages because each electrical connection assembly can be activated individually by passing a current through the resistive heater. Individual and separate activation of each electrical connection assemblies can offer advantages because the entire article need not be heated to cause the fusible conductive material to be reflowed. Individual activation can also offer more flexibility and/or control in attaching one article to another.

Also disclosed herein are devices 500 that include a first portion and a second portion. An example of the first portion of an exemplary device is the article disclosed and exemplified with respect to FIG. 3 above. An example of such a first portion can be seen in FIG. 5 as first portion 591. The components of first portion 591 are numbered similar to those discussed with respect to FIG. 3. The device 500 is shown to include a fused conductive material 532, because it has been reflowed and attached to the second portion 592. Any of the alternative components included in the previously discussed embodiments can (but need not) be included in a first portion 591 to be included in a device as disclosed herein.

The device exemplified in FIG. 5 also includes second portion 592. The second portion 592 includes an active device 515, and a device contact pad 575 electrically connected to the active device 515. In the embodiment depicted in FIG. 5, the active device 515 is depicted as including the entire portion of the second portion 592 that is not otherwise called out herein; it should be understood that the active device 515 can include less than the entire remaining volume of the second portion 592 and/or the second portion 592 can include other components. In embodiments, the active device 515 can include numerous electronic devices, including for example semiconductor devices such as integrated circuits and magnetic recording heads.

The device contact pad 575 is electrically connected to the active device 515. Once the second portion 592 is electrically connected to the first portion 591, as is shown in FIG. 5, the device contact pad 575 can electrically connect the active device 515 in the second portion 592 to external circuitry that is electrically connected to or part of the first portion 591. The device contact pad 575 can generally be made of an electrically conductive material. In embodiments, the device contact pad 575 can generally be made of an electrically conductive material. In embodiments, the device contact pad 575 can be made of copper, gold, titanium, platinum, nickel, or combinations thereof. An exemplary material for the device contact pad 575 includes copper with a nickel/gold protective coating.

The second portion 592 can also optionally include a device insulating layer 585, as seen in FIG. 5. The device insulating layer 585 can function to electrically insulate the contact pad 575 from other portions of the second portion 592. The device insulating layer 585 can also or alternatively function to physically isolate the fusible conductive material 530 once it has been melted and before it is solidified again. In this capacity, the device insulating layer 585 can be characterized as asking like a mask or wick stop layer. This can more effectively maintain the fusible conductive material within a defined area, for example, in physical contact with only the device contact pad 575 once it is melted or reflowed.

An article such as that exemplified in FIG. 5 can not only provide an electrical connection between the first portion 591 and the second portion 592, but can also provide a mechanical connection once the fusible conductive material has been melted, contacted with the second portion 592 and solidified again, it becomes the fused conductive material 532 which provides electrical and mechanical connection. In embodiments the fused conductive material 532 can be subjected to and pass electrical continuity and mechanical shock testing. In embodiments, the fused conductive material 532 can be subjected to and pass recording head shock and vibration testing standards.

Although not depicted herein, the volume surrounding the fused conductive material 532 between the first and second portions 591 and 592 can be backfilled with material. This can increase the mechanical stability and prevent environmental damage to the connection. Commonly utilized materials for backfilling this area include for example underfill adhesives, and epoxies for example.

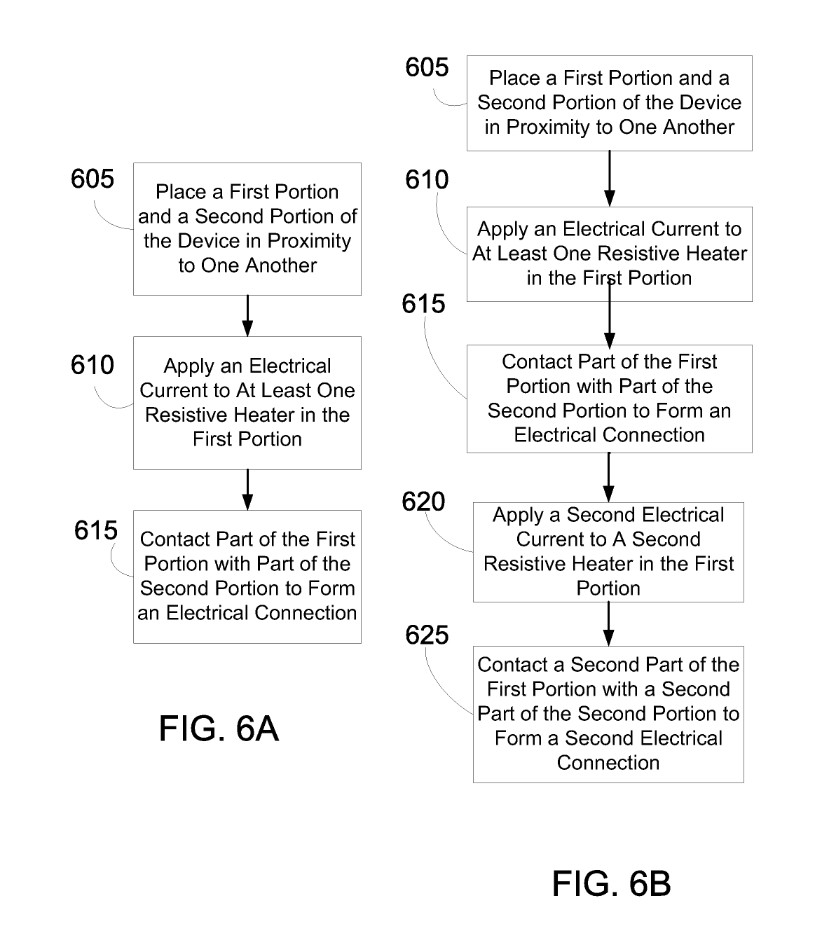

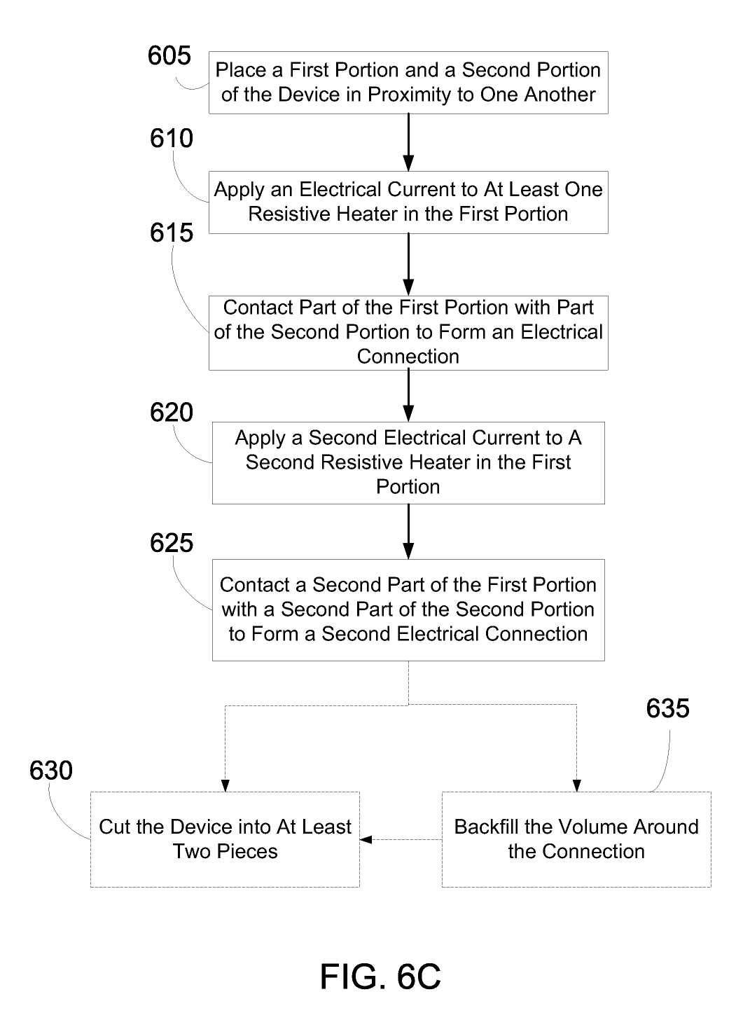

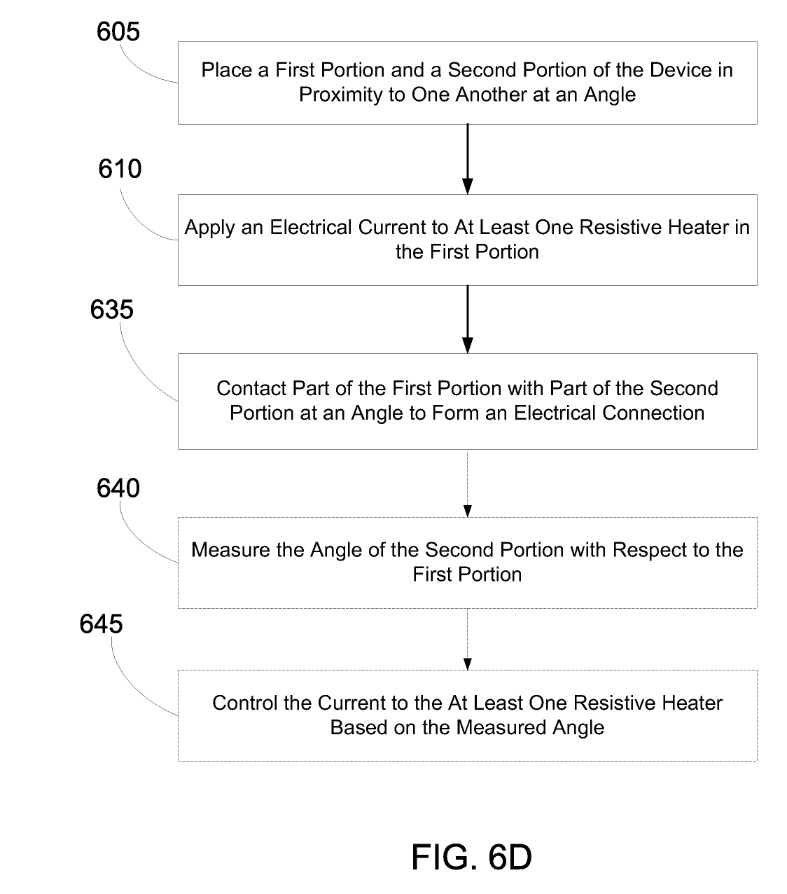

Methods of electrically and physically connecting two portions (such as those discussed above) of a device are also disclosed herein. FIG. 6A is a flow chart depicting an exemplary method as disclosed herein. A first step in such a method includes a first step 605 of placing a first portion and a second portion of a device in proximity to one another. The applicable distance between the two portions of the device can depend on the particular characteristics of the two portions and the active device included in the second portion. The second step, step 610, includes applying an electrical current to at least one resistive heater in the first portion. Application of the electrical current in step 610 functions to melt or reflow the fusible conductive material in at least a first electrical connection assembly. The next step in such a method is step 615, contacting at least part of the first portion with at least part of the second portion to form an electrical and physical connection. This step functions to form an electrical and a physical connection because the fusible conductive material has been melted by step 610 so that bringing the melted or reflowed fusible conductive material in contact with the device contact pad can form an electrical connection. Once the electrical current to the resistive heater is ceased, the fusible conductive material will once again become solid, which will cause the electrical and mechanical connection to be formed. Such a method can also optionally include a step of ceasing application of the electrical current. Alternatively, the electrical current that is applied can be configured as a pulse of a defined length.

The proximity and configuration involved in step 605, the duration and intensity of the electrical current applied in step 610, the pressure involved in the contact in step 615, or combinations thereof can depend at least in part on the particular characteristics of the two portions, the active device included in the second portion, other factors not discussed herein, or some combination thereof. The disclosed steps can be carried out in any order, and one can be carried out while another or multiple steps are being carried out. Specifically, step 610 can be undertaken before, after, or simultaneous with step 605; and step 615 can be undertaken before, after, or simultaneous with step 610.

FIG. 6B depicts another exemplary embodiment of a method as disclosed herein. The method depicted in FIG. 6B can be utilized to electrically and physically connect more than one part of a first portion with a second portion. The method depicted in FIG. 6B includes the steps discussed above with respect to FIG. 6A, but also includes optional steps of applying an electrical current to a second resistive heater, step 620; and contacting a second part of the first portion with a second part of the second portion to form a second electrical connection, step 625.

FIG. 6C depicts further optional steps that can be carried out in methods as disclosed herein. One such method depicted in FIG. 6C can be utilized to electrically and physically connect a first portion and a second portion forming at least two connections and then separating the device into two separate devices. Such an exemplary method includes the steps discussed above with respect to FIG. 6B and also includes the optional step, step 630, of separating or cutting the device into at least two pieces. This can be accomplished using known methods. Another such method depicted in FIG. 6C includes the optional step 635 of backfilling the volume around the connection. This can be accomplished using known materials and methods. Step 635 can also be utilized in methods where only one connection is made. Another exemplary method can include both backfilling (step 635) and cutting (step 630).

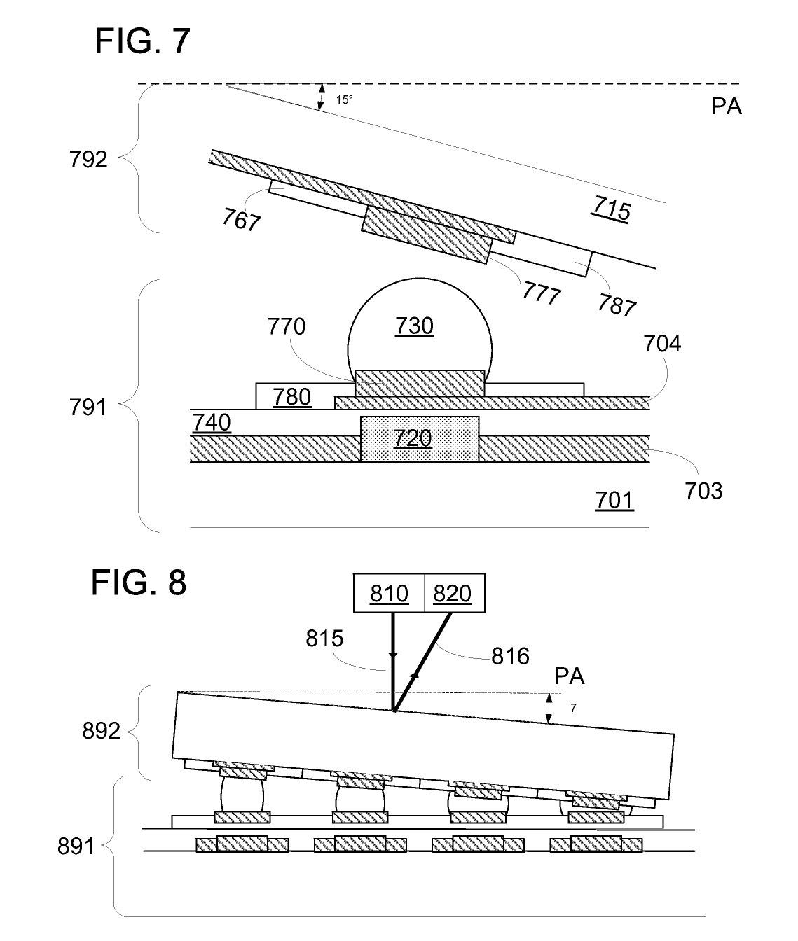

FIG. 6D depicts another exemplary embodiment of a method as disclosed herein. The method depicted in FIG. 6D can be utilized to electrically and physically connect a first and second portion in a configuration where the two portions are not parallel to each other. Such an exemplary method includes steps 605 and 610 as discussed above. Step 635 in such a disclosed method includes contacting part of the first portion with part of the second portion at an angle to form an electrical connection. It should also be noted that step 615, which was discussed above, could also include contacting the two portions at an angle of other than 0° (i.e. other than parallel). The device in FIG. 7 illustrates two exemplary portions of the device just prior to completion of this step. As seen in FIG. 7, the second portion 792 of the device is positioned at an angle with respect to the principle axis (PA) of the first portion 791 of the device. In the particular exemplary embodiment depicted in FIG. 7, the second portion 792 of the device is positioned at an angle of about 15° with respect to the principle axis of the first portion 791 of the device.

In embodiments, the angle of the second portion of the device with respect to the first portion of the device in a first axis can be referred to as the roll angle. In embodiments, the roll angle can be an angle of between about −2° to about +2°. In embodiments, the roll angle can be an angle of between about −0.2° to about +0.2°. In embodiments, the roll angle can be about 0°. In embodiments, the angle of the second portion of the device with respect to the first portion of the device in a second axis can be referred to as the pitch angle. In embodiments, the pitch angle can be an angle of between about 1° and about 5°. In embodiments, the pitch angle can be an angle of between about 1° and 3°. In embodiments, the pitch angle can be an angle of between about 1° and about 2°. In embodiments, the pitch angle can be an angle of about 1.2°.

The method in FIG. 6D also includes an optional step, step 640 of measuring the angle of the second portion with respect to the first portion. The measurement of the angle may be accomplished by bouncing a laser beam off of the second portion and measuring the deflection of the laser beam. The measurement of the angle may also be accomplished using interferometer (count fringes) or a side view camera for example. Equipment and processes necessary for measurement of the angle would be known to one of skill in the art, having read this specification.

In embodiments, the angle can be measured using a laser beam. A schematic illustration of an exemplary system for carrying out this method of measuring the angle is depicted in FIG. 8. The system in FIG. 8 illustrates the first portion 891 of the device and the second portion 892 of the device that are contacted at an angle of about 7° to the principle axis PA of the first portion 891. As seen in FIG. 8, a laser source 810 generates a laser beam 815 that is directed towards the backside (non-bonded side) of the second portion 892. The laser beam 815 hits the second portion 892 and is deflected back in a deflected beam 816 towards a detector 820 which can be configured to determine the angle of the second portion 892 with respect to the principle axis PA of the first portion 891.

The method in FIG. 6D also includes a second optional step, step 645 of controlling the current to the at least one resistive heater based on the angle measured in step 640. The particular angle measured, once fed to a current controller (not pictured) can then be used to control the amount of current passed through the resistive heater. The particular angle or angles can also be used to control the current to more than one resistive heater. This can function to melt each fusible conductive material at a specific time, for a controlled duration, thereby collapsing the fusible conductive materials to different sizes causing the recording head to lie at a desired inclined angle with respect to the principle axis. It should be noted that methods including any of steps 635, 640, and 645 can be utilized to contact the second portion to the first portion with any final angle, including 0° with respect to the principle axis.

The step of controlling the current to the at least one resistive heater based on the angle measured can also include controlling the heating sequence. For example the order in which the resistive heaters are activated can be controlled to control which bonds are reflowed and/or frozen first, second, and so on. This can be relevant because in an example where all but one fusible conductive material is reflowed, the one fusible conductive material not reflowed will be thicker than the rest. This scenario can cause an adjustment of the angle of the two portions of the device. Solidifying the appropriate combinations in a particular sequence can be utilized to further adjust the angle of the two portions of the device to a desired value.

Thus, embodiments of INTEGRATED RESISTIVE HEATERS FOR MICROELECTRONIC DEVICES AND METHODS UTILIZING THE SAME are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation, and the present disclosure is limited only by the claims that follow.

What is claimed is:

1. A device comprising:
a substrate having a first surface and a second opposing surface; and
at least one electrical connection assembly, wherein each electrical connection assembly comprises:
a resistive heater disposed on the first surface of the substrate, wherein the resistive heater is electrically connected to a circuit via a heater electrical connection;
an electrical connection precursor, wherein the electrical connection precursor comprises a fusible conductive material that is electrically connected to a lead; and
a first insulating layer,
wherein the resistive heater is disposed beneath the electrical connection precursor, wherein the first insulating layer functions to electrically insulate the resistive heater and the heater electrical connection from the electrical connection precursor and the lead, and wherein activation of the resistive heater functions to at least partially flow the fusible conductive material,
wherein each electrical connection assembly can be activated individually by passing a current through the resistive heater.

2. The device according to claim 1, wherein the electrical connection precursor further comprises a contact pad, which is electrically and physically connected to the fusible conductive material.

3. The device according to claim 2, further comprising a second insulating layer that electrically isolates the resistive heater of one electrical connection assembly from the resistive heater of another electrical connection assembly.

4. The device according to claim 1, wherein the first insulating layer comprises alumina (Al₂O₃), zirconia (ZrO₂), silicon dioxide (SiO₂), silicon nitride (Si₃N₄), polyimide, polyimide laminates, epoxy, epoxy laminates, photoresist, or combinations thereof.

5. The device according to claim 4, wherein the first insulating layer has a thickness of less than about 100 nanometers between the resistive heater and the electrical connection precursor.

6. The device according to claim 1, wherein the first insulating layer comprises aluminum nitride (AlN), beryllium oxide (BeO), diamond, diamond like carbon (DLC), or chemical vapor deposited (CVD) diamond.

7. The device according to claim 6, wherein the first insulating layer has a thickness from about 10 μm to about 100 μm.

8. The device according to claim 1, wherein the resistive heater comprises copper, nickel, nichrome, tungsten, titanium, vanadium, platinum, germanium, silicon or combinations thereof.

9. A device comprising:
a. a first portion, the first portion comprising:
a substrate having a first surface and a second opposing surface; and
at least one electrical connection assembly, wherein each electrical connection assembly comprises:
a resistive heater disposed on the first surface of the substrate, wherein the resistive heater is electrically connected to a circuit via a heater electrical connection;
an electrical connection precursor, wherein the electrical connection precursor comprises a fusible conductive material that is electrically connected to a lead; and
a first insulating layer,
wherein the resistive heater is disposed beneath the electrical connection precursor, wherein the first insulating layer functions to electrically insulate the resistive heater and the heater electrical connection from the electrical connection precursor and the lead, and wherein activation of the resistive heater functions to at least partially melt the fusible conductive material,
wherein each electrical connection assembly can be activated individually by passing a current through the resistive heater; and
b. a second portion, the second portion comprising:
an active device; and a device contact pad electrically connected to the active device,
wherein the device contact pad of the second portion and the fusible conductive material of the first portion are electrically and physically connected affording electrical control of the active device through the first portion of the device.

10. The device according to claim 9, wherein the active device comprises one or more magnetic recording heads.

11. The device according to claim 9, wherein the electrical connection precursor further comprises a contact pad, which is electrically and physically connected to the fusible conductive material.

12. The device according to claim 9, wherein the first insulating layer comprises alumina (Al₂O₃), zirconia (ZrO₂), silicon dioxide (SiO₂), silicon nitride (Si₃N₄), polyimide, polyimide laminates, epoxy, epoxy laminates, photoresist, or combinations thereof and the first insulating layer has a thickness of less than about 100 nanometers between the resistive heater and the electrical connection precursor.

13. The device according to claim 9, wherein the first insulating layer comprises aluminum nitride (AlN), beryllium oxide (BeO), diamond, diamond like carbon (DLC), or chemical vapor deposited (CVD) diamond and the first insulating layer has a thickness from about 10 μm to about 100 μm.

14. The device according to claim 9, wherein the resistive heater comprises copper, nickel, nichrome, tungsten, titanium, vanadium, platinum, germanium, silicon or combinations thereof.

15. A method of electrically and physically connecting two portions of a device, the method comprising the steps of:
a. placing a first portion of the device in proximity with a second portion of the device, wherein the first portion comprises:
a substrate having a first surface and a second opposing surface; and
at least one electrical connection assembly, wherein each electrical connection assembly comprises:
a resistive heater disposed on the first surface of the substrate, wherein the resistive heater is electrically connected to a circuit via a heater electrical connection;
an electrical connection precursor, wherein the electrical connection precursor comprises a fusible conductive material that is electrically connected to a lead; and
a first insulating layer,
wherein the resistive heater is disposed beneath the electrical connection precursor, wherein the first insulating layer functions to electrically insulate the resistive heater and the heater electrical connection from the electrical connection precursor and the lead, and wherein activation of the resistive heater functions to at least partially melt the fusible conductive material,
wherein each electrical connection assembly can be activated individually by passing a current through the resistive heater; and
the second portion comprises:
an active device; and a device contact pad electrically connected to the active device
b. passing a current through the resistive heater of the first connection assembly causing the fusible conductive material to at least partially melt; and
c. contacting part of the first portion with part of the second portion to form an electrical and physical connection between the first portion and the second portion to form a device.

16. The method according to claim 15, wherein the first portion of the device comprises more than one electrical connection assembly; and the second portion comprises more than one active device.

17. The method according to claim 15 further comprising passing a current through the resistive heater of the second electrical connection assembly and contacting a second part of the first portion with a second part of the second portion to form a second electrical connection between the first portion and the second portion.

18. The method according to claim 17 further comprising separating the device into at least two functional devices.

19. The method according to claim 15 further comprising measuring the angle of the second portion with respect to the principle axis of the first portion.

20. The method according to claim 19 further comprising controlling the current to at least one resistive heater of a connection assembly based at least in part on the measured angle.
